(19) United States
(12) Patent Application Publication
(10) Pub. No.: US 2016/0005031 A1
(43) Pub. Date: Jan. 7, 2016

(54) CRYPTOGRAPHIC LABEL FOR ATTACHMENT TO A COMMUNICATION CARD

(71) Applicant: VISA INTERNATIONAL SERVICE ASSOCIATION, San Francisco, CA (US)

(72) Inventors: Alan Joseph O'REGAN, Cape Town (ZA); Horatio Nelson HUXHAM, Cape Town (ZA)

(21) Appl. No.: 14/772,153

(22) PCT Filed: Mar. 4, 2014
(86) PCT No.: PCT/IB2014/059414

§ 371 Date: Sep. 2, 2015

(30) Foreign Application Priority Data
Mar. 4, 2013 (ZA) 2013/01625

(51) Int. Cl. G06Q 20/36; G06Q 20/38

(52) U.S. Cl. CPC G06Q 20/367; G06Q 20/382; G06Q 2220/00

(57) ABSTRACT

A cryptographic label is provided for enabling a mobile communications device to perform secure communications. The label comprises a flexible printed circuit having a first set of electrical contacts disposed on a top side of the circuit for interfacing to a mobile communications device, a second set of electrical contacts disposed on a bottom side of the circuit for interfacing to a communication card, and a hardware security module disposed in the circuit and coupled to the first and second sets of electrical contacts. The label is characterised in that it further includes a skirt attached to the flexible printed circuit, the skirt having an adhesive portion on at least a bottom side thereof which, in use, bonds to a communication card to attach the label to the communication card. The skirt is capable of having printed indicia provided on a top side thereof.

### BACKGROUND

In developing countries and rural areas, many people may lack access to banking services from traditional brick-and-mortar banks. In such areas, a bank may be physically located too far away for a majority of the population to travel to. Even if a bank is nearby, it may be the only banking location in the vicinity of a vast region covering a large number of the population. The brick-and-mortar bank may not have the resources and capacity to adequately support such a large number of customers, possibly resulting in long waiting times and inconvenience for the bank's customers. In some developing countries, building additional bank branches and/or installing financial infrastructure such as automated teller machines (ATMs) at various locations is often not a viable solution due to the relatively high costs involved.

In recent years, the use of mobile devices in developing countries has grown rapidly. As such, one way of providing these communities with access to banking services is to enable users of mobile devices to perform mobile banking transactions, such as making mobile payments or money transfers, or checking account balances or performing other account related services, directly from their mobile devices. However, security concerns may be considered a stumbling block that hinders the wide adoption and growth of mobile banking.

Some mobile devices, especially older generation models that are typically used in developing countries, may lack the capability to securely send end-to-end encrypted communication. As a result, sensitive financial information, such as a Personal Identification Numbers (PINs) and Primary Account Numbers (PANs), might be transmitted or stored “in the clear”, creating vulnerability in that such information may be intercepted by malicious parties and used for fraudulent purposes.

Devices which can be linked to a communication component of a communication device to enable the communication device to perform cryptographic operations on communications sent to and from the device are known.

An example of such a device is known as a cryptographic expansion device and enables the communication device to send and receive end-to-end secure encrypted communications. The end-to-end secure communications enabled by the cryptographic expansion device may be utilized by a user of a mobile communications device such as a mobile phone to perform, for example, mobile banking transactions.

The cryptographic expansion device can be a manufactured in the form of a cryptographic label. The cryptographic label contains one or more integrated circuits and attaches to the communication component of the communication device. The device typically further includes a coupling element so that the label can be attached to the communication component.

In a particular embodiment of the cryptographic label, the communication device is a mobile phone, the communication component is a Subscriber Identity Module (SIM) card, and the label is attached to the surface of the SIM card similarly to an adhesive label or a sticker.

A disadvantage associated with a cryptographic label of the type described above is that the circuit may be constructed from a relatively expensive substrate. In order to manufacture the cryptographic label, the entire label, which is of similar length and width to the SIM card it is to be attached to, may in some cases be manufactured as a flexible printed circuit. This may increase the costs to manufacture the cryptographic label, as well as ultimate retail prices.

Another drawback of the cryptographic label of the type described above is that branding challenges may be involved, seeing as the color of the cheapest, most easily accessible flexible printed circuits is generally black. Black flexible printed circuits may be undesirable, considering that many printing methods may not be adequate for printing indicia such as logos or brand names particularly on the black cryptographic label. Furthermore, indicia which are eventually successfully added to the label may not be sufficiently visible.

There is thus a need for reducing the cost to manufacture cryptographic expansion devices, such as the cryptographic labels of the type described above. There is also a need for facilitating the addition of indicia to such cryptographic labels, while not substantially inhibiting its functionality.

### BRIEF SUMMARY

In accordance with this invention there is provided a cryptographic label for enabling a mobile communications device to perform secure communications, the label comprising a flexible printed circuit having a first set of electrical contacts disposed on a top side of the circuit for interfacing to the mobile communications device, a second set of electrical contacts disposed on a bottom side of the circuit for interfacing to a communication card, and a hardware security module (HSM) disposed in the circuit and coupled to the first and second sets of electrical contacts, the label characterised in that it further comprises a skirt that is attached to the flexible printed circuit, the skirt having an adhesive portion on at least a bottom side thereof and capable of having printed indicia provided on a top side thereof, wherein, in use, the adhesive portion on the bottom side of the skirt bonds to a communication card so as to attach the cryptographic label to the communication card.

Further features of the invention provide for the skirt to be a planar extension member generally coplanar to the flexible printed circuit; for the flexible printed circuit to be attached to the adhesive portion on the bottom side of the skirt; and for the skirt to partially extend over at least two edges of the flexible printed circuit such that at least two edges of the bottom side of the skirt rests on the top side of the flexible printed circuit.

In one embodiment of the invention, the flexible printed circuit is attached to the bottom side of the skirt, and the skirt includes a set of separately insulated pass-through type conductive channels which extend from the top side to the bottom side of the skirt. The conductive channels serve to electrically couple the first set of electrical contacts of the flexible printed circuit to a mobile communications device interface so as to enable the cryptographic label to interface to the mobile communications device.

Further features of the invention provide for the skirt to include an adhesive portion on a top side thereof; for the bottom side of the flexible printed circuit to be attached to the adhesive portion on the top side of the skirt; and for the skirt to include a set of separately insulated pass-through type conductive channels which extend from the top side to the bottom side of the skirt, the conductive channels serving to electrically couple the second set of electrical contacts of the flexible printed circuit to the communication card so as to enable the cryptographic label to interface to the communication card when the flexible printed circuit is attached to the top side of the skirt.

The skirt may include one or more openings therein so as to enable electrical contacts of the flexible printed circuit to interface to the communication card or the mobile communications device through the openings. In embodiments of the invention, the skirt is provided with a single central opening.

Further features of the invention provide for the skirt to be manufactured substantially from non-conductive materials; for the skirt to be manufactured substantially from flexible plastics material; and for the skirt to have a length and a width substantially similar to a length and a width of the communication card the cryptographic label is to be attached to.

A further feature of the invention provides for the skirt to be sufficiently thin to permit the cryptographic label to be inserted into a communication card receiving slot of the mobile communications device when attached to the communication card.

Further features of the invention provide for the mobile communications device to be a mobile phone; for the communication card to be a Subscriber Identity Module (SIM) card; and for the cryptographic label to interface to the mobile communications device when received in a SIM card receiving slot of the mobile communications device in use.

Yet further features of the invention provide for the flexible printed circuit to be provided with at least two edge portions having surfaces devoid of circuitry, the at least two edge portions defining an attachment area for attachment of the skirt to the flexible printed circuit; and for the HSM to include a public processing unit and a secure processing unit, the secure processing unit being accessible by the communication card and/or the mobile communications device only through the public processing unit.

The invention extends to a method of assembling a cryptographic label for enabling a mobile communications device to perform secure communications, the method comprising: providing a flexible printed circuit, the flexible printed circuit having a first set of electrical contacts disposed on a top side of the circuit for interfacing to the mobile communications device, a second set of electrical contacts disposed on a bottom side of the circuit for interfacing to a communication card, and a hardware security module (HSM) disposed in the circuit and coupled to the first and second sets of electrical contacts; providing a skirt, the skirt having an adhesive portion on at least a bottom side thereof and capable of having printed indicia provided on a top side thereof; and attaching the skirt to the flexible printed circuit to form the cryptographic label, such that, in use, the adhesive portion on the bottom side of the skirt bonds to a communication card so as to attach the cryptographic label to the communication card.

Further features of the invention provide for the step of attaching the skirt to the flexible printed circuit to include attaching the flexible printed circuit to the adhesive portion on the bottom side of the skirt; alternatively, for the step of attaching the skirt to the flexible printed circuit to include attaching the flexible printed circuit to an adhesive portion on the top side of the skirt.

In order for the invention to be more fully understood, implementations thereof will now be described with reference to the accompanying drawings.

### BRIEF DESCRIPTION OF THE DRAWINGS

FIG. 1 is an exploded three-dimensional view of a first embodiment of a cryptographic label according to the invention and a Subscriber Identity Module (SIM) card it is attached to in use;

FIG. 2 is a sectional view of a flexible printed circuit of the cryptographic label of FIG. 1;

FIG. 3 is a three-dimensional view of the embodiment of FIG. 1, wherein the cryptographic label is attached to an underlying SIM card;

FIG. 4 is a schematic illustration of a sectional view of a cryptographic label according to an embodiment of the invention;

FIG. 5 is an exploded three-dimensional view of a second embodiment of a cryptographic label in according to the invention;

FIG. 6 is an exploded three-dimensional view of a third embodiment of a cryptographic label according to the invention;

FIG. 7 is an exploded three-dimensional view of a fourth embodiment of a cryptographic label in accordance with the invention;

FIG. 8A is a schematic illustration of an exemplary attachment arrangement for attaching a flexible printed circuit to a skirt according to the invention;

FIG. 8B is a schematic illustration of an exemplary attachment arrangement for attaching a flexible printed circuit to a skirt according to the invention;

FIG. 9 illustrates a block diagram of a communication device that can be used in various embodiments of the invention.

### DETAILED DESCRIPTION

A first embodiment of a cryptographic label (100) for enabling a communications device to perform secure communications is shown in FIG. 1. The cryptographic label (100) comprises a flexible printed circuit (102) and a skirt (104) that is attached to the flexible printed circuit (102).

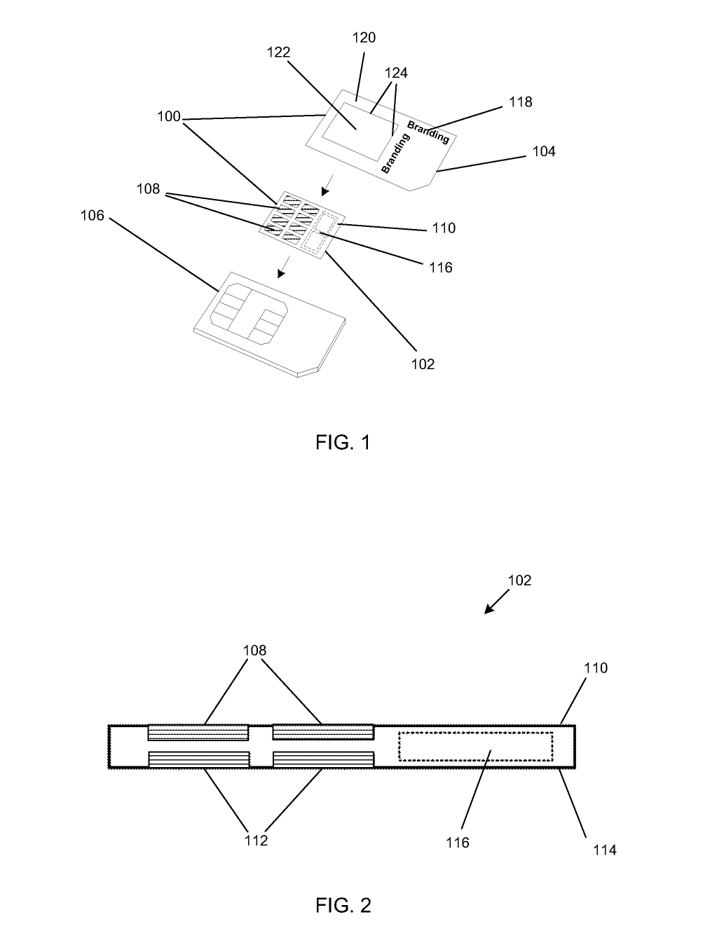

An adhesive portion on the bottom side of the skirt (104) bonds to a communication card, in use, so as to attach the cryptographic label (100) to the communication card. In the embodiment of FIG. 1, the communication card is a Subscriber Identity Module (SIM) card (106). The SIM card (106) is also shown in FIG. 1 to illustrate the attachment of the cryptographic label (100) to the SIM card (106). A sectional view of the flexible printed circuit (102) of the first embodiment is shown in FIG. 2.

The skirt (104) is typically, and as is the case in this embodiment, a planar extension member generally coplanar to the flexible printed circuit (102) it is attached to. The skirt (104) and flexible printed circuit (102) are sufficiently thin to permit the cryptographic label (100) to be inserted into a communication card receiving slot of the mobile communications device when attached to a communication card. In this embodiment, the dimensions permit the cryptographic label (100) to be inserted into a SIM card receiving slot of a communication device such as a mobile phone when attached to the SIM card (106).

The directional arrows in FIGS. 1, 5, 6 and 7 demonstrate the manner and orientation in which the skirt (104) is attached to the flexible printed circuit (102) to form the cryptographic label (100), and how the cryptographic label (100) is attached to the SIM card (106). The cryptographic label (100) may generally have a form factor of planar dimensions similar to that of the SIM card (106) it is to be attached to.

The cryptographic label (100) may be thinner than the communication card it is to be attached to so as to ensure that the communication card with attached label fits into a communication card receiving slot of a relevant communication device.

The flexible printed circuit (102) includes a first set of electrical contacts (108) disposed on a top side (110) thereof for interfacing to the communications device, for example via a SIM card receiving slot, a second set of electrical contacts (112) disposed on a bottom side (114) of the flexible printed circuit (102) for interfacing to the SIM card (106), and a hardware security module (HSM) (116) disposed in the circuit (102) and coupled to the first (108) and second (112) sets of electrical contacts.

In the embodiments of the invention shown in FIGS. 1 to 7, the sets of electrical contacts on each side of the circuit have eight contact pads. There may alternatively be, for example, six contact pads on each side of the circuit for interfacing to the communication device and the SIM card when some interfacing signals are not used. Any suitable set of electrical contacts or electrical coupling element may, of course, be employed in other embodiments.

The skirt (104) has an adhesive portion on a bottom side thereof, and further includes indicia in the form of printed branding (118) provided on a top side (120) thereof in some embodiments. FIGS. 8A and 8B illustrate exemplary adhesive portions and are more fully described below.

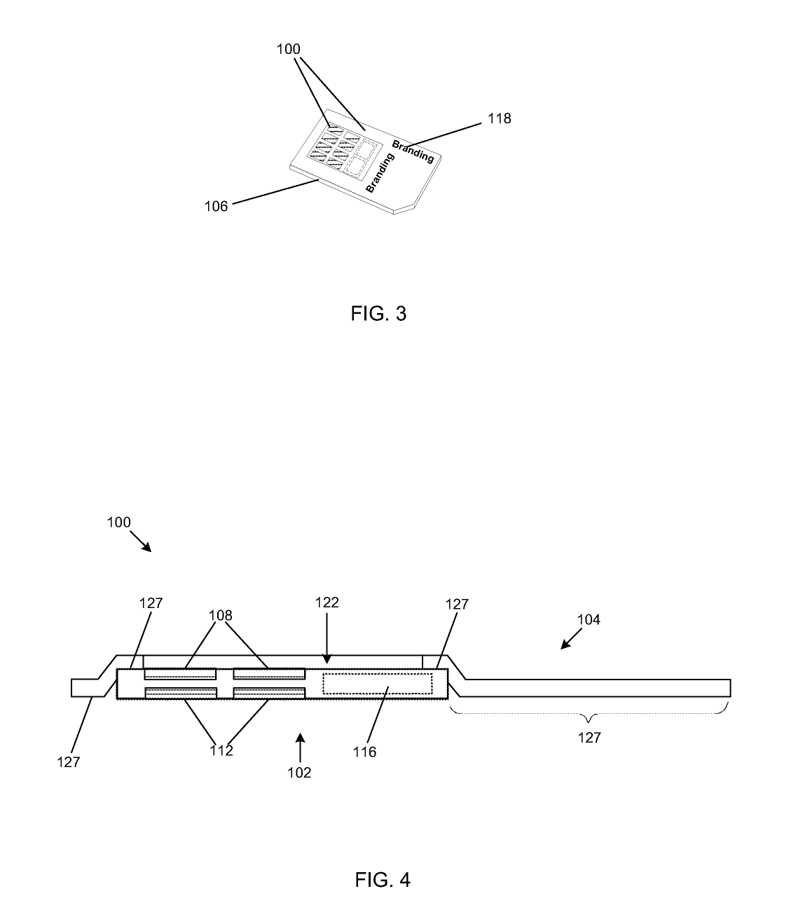

The adhesive portion on the bottom side of the skirt (104) bonds to the top side (110) of the flexible printed circuit (102) and to the SIM card (106) so as to attach the cryptographic label (100) to the SIM card (106) in use, as is shown in FIG. 3.

In the first embodiment of the invention, the skirt (104) includes a central opening (122) therein. This enables four inner edges (124) of the skirt (104) to extend slightly over and rest on top of outer edges on the top side (110) of the flexible printed circuit (102), so as not to extend over the first set of electrical contacts (108) to enable the contacts (108) to correctly interface with the communication device in use.

Various configurations may exist to allow correct interfacing with the communication device. Preferably, the skirt at least partially extends over at least two edges of the flexible printed circuit such that at least two edges of the bottom side of the skirt rests on the top side of the flexible printed circuit.

A non-conductive adhesive may preferably be used for the adhesive material disposed on the skirt (104), while the skirt (104) itself may preferably be manufactured from a flexible or semi-flexible substrate, such as plastic, to facilitate the application of the cryptographic label (100) to the SIM card (106) in a manner similar to an adhesive label or a sticker. In embodiments of the invention, the skirt is manufactured substantially from non-conductive materials.

It should be noted that although the flexible printed circuit is shown to be semi-transparent in all some of the representations, the circuit is shown as such for illustrative purposes. Thus, in some implementations, the HSM may not be visible from the top of the cryptographic label when the label is attached to the SIM card, as it is illustrated in FIG. 3.

It should also be appreciated that the bottom side of the skirt (104) may extend over the flexible printed circuit (102) so as to cover the area containing the HSM (116) without inhibiting successful coupling between the first set of electrical contacts (108) and the communication device.

FIG. 3 illustrates a three-dimensional view of the first embodiment of the invention, wherein the label (100) is attached to the underlying SIM card (106) as described above. The branding (118), or any other indicia, typically of a commercial or marketing nature, may, of course, be applied to the cryptographic label (100) in various forms without departing from the scope of the invention. The branding (118) may, for example, be printed branding, embossed branding, or branding applied to a surface of the cryptographic label (100) by means of an adhesive material or any other suitable attachment process. Importantly, the skirt is manufactured from a material or materials capable of relatively easily having indicia provided thereon. The indicia may, for example, represent a logo or distinguishing mark associated with one or more manufacturers, retailers or other commercial entities.

FIG. 4 is a schematic illustration of a sectional view of a cryptographic label (100) according to an embodiment of the invention. In this embodiment, the flexible printed circuit (102) is attached to the adhesive portion (127) on the bottom side of the skirt (104). The adhesive portion (127) on the bottom side of the skirt (104) provides an area of attachment for the top side of the flexible printed circuit (102) and an area of attachment for bonding to a communication card. As can be seen in FIG. 4, the skirt (104) and flexible printed circuit (102) extend substantially in the same plane to allow, for example, a SIM card with attached cryptographic label to fit into a SIM card receiving slot of a mobile phone.

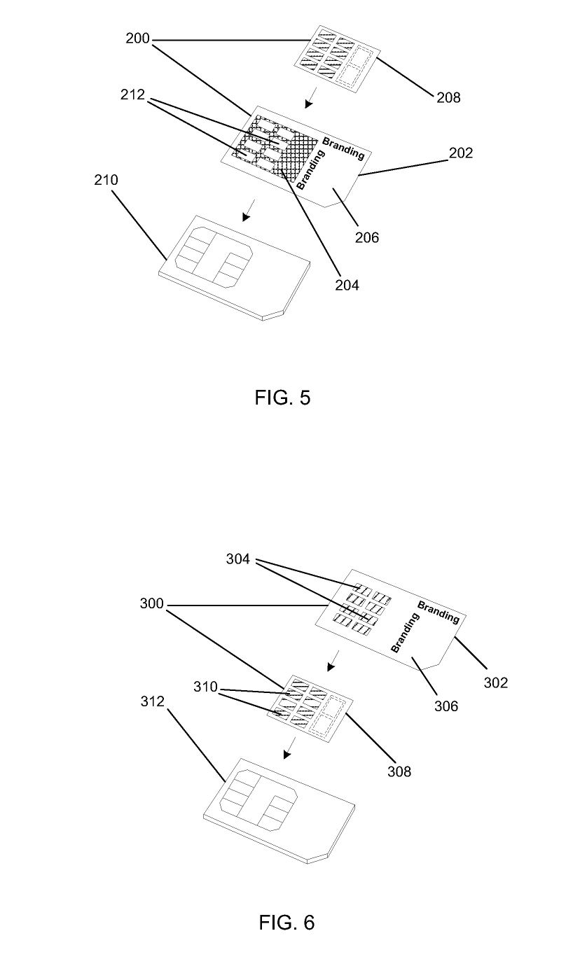

A second embodiment of a cryptographic label (200) for enabling a communications device to perform secure communications is shown in FIG. 5. In this embodiment, the thin skirt (202), in addition to the adhesive portion on its bottom side, further includes an adhesive portion (204) on the top side (206) thereof. The bottom side of the flexible printed circuit (208) is attached to the adhesive portion (204) on the top side (206) of the skirt (202), as illustrated by the upper directional arrow in FIG. 4.

To ensure that the second set of electrical contacts correctly couples to the SIM card (210) without interference by the skirt (202), the skirt (202) includes a set of openings (212) to enable the second set of electrical contacts of the flexible printed circuit (208) to interface to the SIM card (210) when the circuit (208) is attached to the top side (206) of the skirt (202).

The embodiment shown in FIG. 4 includes eight openings (212) in the skirt (202). It should be noted that any number of openings may be included in the skirt (202), or that a single opening may be included in the skirt (202) to carry out the function described above. The opening or openings need not be a central opening and may extend through one or more longitudinal or lateral edges of the skirt.

Generally, any suitable configuration employing one or more central or other openings in the skirt so as to enable electrical contacts of the flexible printed circuit to interface to the communication card or the mobile communications device through the openings may be used without departing from the scope of the invention.

Similarly to the first embodiment, the adhesive bottom side of the skirt (202) of FIG. 5 bonds to the SIM card (210) so as to attach the cryptographic label (200) to the SIM card (210). In contrast to the first embodiment, the flexible printed circuit (208) bonds to the top side (206) of the skirt (202).

A third embodiment of a cryptographic label (300) for enabling a communications device to perform secure communications is shown in FIG. 6. In this embodiment, the skirt (302) is substantially solid and includes a set of separately insulated pass-through type conductive channels (304) which extend from the top side (306) to the bottom side of the skirt (302). The top side (306) of the skirt (302) does not include an adhesive portion.

The top side of the flexible printed circuit (308) is attached to the adhesive bottom side of the skirt (302) so as to bring each of the contact pads of the first set of electrical contacts (310) into contact with one of the conductive channels (304). The adhesive portion on the bottom side of the skirt (302) bonds to the SIM card (312) so as to attach the cryptographic label (300) to the SIM card (312). The conductive channels (304) ensure that the first set of electrical contacts (310) is correctly coupled with the communication device, in order to allow the cryptographic label (300) to interface to the communication device in use.

The conductive channels may be manufactured from any suitable conductive material. In some embodiments, the conductive channels are copper or consist substantially of copper.

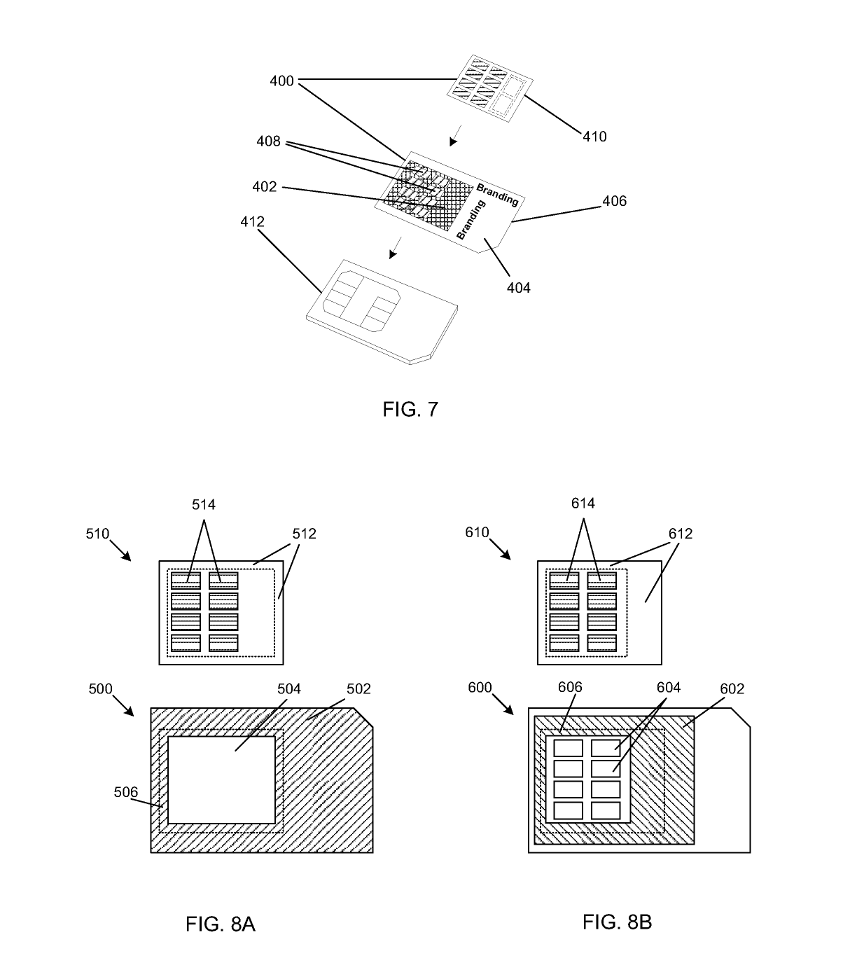

In a fourth embodiment of a cryptographic label (400) for enabling a communications device to perform secure communications, as illustrated in FIG. 7, the skirt (406) is provided with an adhesive portion (402) surrounding the conductive channels (408) on the top side (404).

It should be appreciated that conductive adhesive material may also be used, particularly in the third and fourth embodiments, so that the adhesive material may cover the conductive channels on the top and bottom sides of the skirt or replace the conductive channels so as to enlarge the adhesive surface area for attachment to the flexible printed circuit and/or the communication card. For example, a conductive adhesive material may cover the conductive channels (408) to enlarge the adhesive surface of the skirt (406) that the flexible printed circuit (410) is to be attached to, while ensuring the cryptographic label (400) remains electrically coupled to the SIM card (412).

Exemplary adhesives which are electrically conductive may consist of a polymeric resin such as an epoxy or a silicone resin that provides adhesive properties, and includes conductive filler such as silver, gold, or copper such that the adhesive conducts electricity.

In the embodiment shown in FIG. 7, the bottom side of the flexible printed circuit (410) is attached to the adhesive material (402) on the top side (404) of the skirt (406), and the adhesive bottom side of the skirt (406) bonds to the SIM card (412) so as to attach the cryptographic label (400) to the SIM card (412). The conductive channels (408) ensure that the second set of electrical contacts of the flexible printed circuit (410) is correctly coupled to the SIM card (412), so as to allow the cryptographic label (400) to interface to the SIM card (412) in use.

The flexible printed circuit may be provided with at least two edge portions having surfaces devoid of circuitry, these portions defining an attachment area for attachment of the skirt to the flexible printed circuit. FIGS. 8A and 8B are schematic illustrations of exemplary attachment arrangements for attaching a flexible printed circuit to a skirt according to the invention.

A bottom side of a skirt (500) and a top side of a flexible printed circuit (510) are schematically illustrated in FIG. 8A. The bottom side of the skirt (500) is provided with an adhesive portion (502) spanning the entire bottom side, and a central opening (504) substantially as described with reference to preceding embodiments of the invention.

The surfaces surrounding the four edges of the flexible printed circuit (510) are devoid of circuitry and define an attachment area (512) corresponding to an attachment zone (506) on the bottom side of the skirt, the attachment area (512) and attachment zone (506) being indicated by broken lines in FIG. 8A. When assembling the cryptographic label, the attachment area (512) is bonded or otherwise attached to the adhesive attachment zone (506) such that the flexible printed circuit (510) is attached to the skirt (500), and such that the first set of electrical contacts (514) of the flexible printed circuit (510) can interface to the communication device through the opening (504) in use.

A bottom side of a skirt (600) and a top side of a flexible printed circuit (610) are schematically illustrated in FIG. 8B. The bottom side of the skirt (600) is provided with an adhesive portion (602), and a set of openings (604) substantially as described with reference to preceding embodiments of the invention.

In this example, and similarly to the schematic illustration of FIG. 8A, the surfaces surrounding the four edges of the flexible printed circuit (610) are devoid of circuitry and define an attachment area (612) corresponding to an attachment zone (606) on the bottom side of the skirt, the attachment area (612) and attachment zone (606) being indicated by broken lines in FIG. 8B. To provide a greater overall surface area for attachment between the flexible printed circuit (610) and the skirt (600), the attachment area (612) and corresponding attachment zone (606) have greater surface areas. To assemble the cryptographic label, the skirt (600) and flexible printed circuit (610) are bonded such that the attachment area (612) on the flexible printed circuit (610) adheres to the attachment zone (606) in the adhesive portion (602) of the skirt (600).

The term “HSM” as used in this description refers to the integrated circuits disposed in the cryptographic label, which include embedded processors and storage capabilities. When used with a communication card in a communication device, the cryptographic label acts as a cryptographic expansion device to provide the communication device with the same set of security features as found in industry-standard HSMs.

The cryptographic label may be capable of running a secure operating system and provides secure key management to generate cryptographic keys, sets the capabilities and security limits of keys, implements key backup and recovery, prepares keys for storage and performs key revocation and destruction. The cryptographic label may also encrypt data and user input using Data Encryption Standard (DES), Triple Data Encryption Standard/Algorithm (TDES/TDEA), DES-X, Secure Socket Layer (SSL), Advanced Encryption Standard (AES), Blowfish, Serpent, Twofish, Threefish, International Data Encryption Algorithm (IDEA), Rivest, Shamir, & Adleman (RSA), Digital Signature Algorithm (DSA), Tiny Encryption Algorithm (TEA), extended TEA (XTEA), and/or other encryption algorithms or protocols.

The cryptographic label is preferably implemented as a dual processor device that includes a Federal Information Processing Standards (FIPS)-compliant secure processor with storage and a public processor with storage. This division in hardware roles introduces a high level of security by providing a physical and logical separation between interfaces that are used to communicate critical security parameters and other interfaces that are used to communicate other data. Furthermore, the secure processor and storage component is inaccessible without the master key used during manufacturing.

An electronic device that solely uses software to encrypt communications may comply with only a security level 1 of the FIPS 140-2 standard, which provides only a minimum level of security to protect sensitive information. In contrast, a communications device coupled to an HSM according to embodiments of the invention is compliant with at least a security level 2 of the FIPS 140-2 standard. More preferably, the communications device is compliant with security level 3 or security level 4 of FIPS 140-2.

The HSM in embodiments of the invention uses hardware to encrypt data instead of solely performing the encryption in software. The HSM provides enhanced protection over software encryption technologies. For example, the HSM provides secure key management to generate cryptographic keys, sets the capabilities and security limits of keys, implements key backup and recovery, prepares keys for storage and performs key revocation and destruction.

The HSM disposed in the cryptographic label according to the invention may act as an intermediary between a communication card and a communication device, intercepting and encrypting data such that it reaches the communication card or the communication device, whatever the case may be, in an encrypted format.

To provide enhanced security, the secure processing unit is typically accessible by the communication component or communication device only through the public processing unit. In a preferred embodiment, payment credentials are stored in a secure memory on the HSM to allow a user to conduct secure banking and/or other financial transactions. The payment credentials may include full track data required to conduct a conventional card-present type transaction or a conventional card-not-present type transaction.

The SIM cards as shown in FIGS. 1, 3, 5, 6 and 7 have the form factor of a mini-SIM card. The cryptographic label, however, is not limited to a single form factor. Various form factors may be manufactured and assembled such that cryptographic labels may be attached to SIM cards of various sizes. For example, the label can have a form factor to accommodate a full-sized SIM card or a mini-SIM card as specified in the ISO/IEC 7810 standard, or be shaped to be attached to a micro-SIM card or a nano-SIM card as specified in the ETSI TS 102 221 standard.

It should be appreciated that the throughout this specification the terms “SIM card” and “communication card” should be interpreted so as to have their broadest meanings, and should particularly be interpreted so as to include any Universal Integrated Circuit Card (UICC) for use with a mobile communications device for enabling communications to be sent thereto and transmitted therefrom over a communications network.

In alternative embodiments, the cryptographic label may be configured to be attached to a communication card other than a SIM card. For example, the cryptographic label may be configured to be attached to a communication card in the form of a memory card or other type of smartcard.

The skirt and typically the cryptographic label itself may have a length and a width substantially similar to a length and a width of the communication card the cryptographic label is to be attached to. Alternatively, the cryptographic label may have a form factor with one or more planar dimensions that is different to a corresponding planar dimension of the communication card which it attaches to, if the size of the label does not prevent the communication card from being used with a desired communication device. The skirt may, for example, be substantially square in planar form factor.

It is foreseen that the communication device may be a mobile phone, and that the secure communications may generally relate to financial transactions being performed by a user of the mobile phone.

In addition to attaching the cryptographic label to the communication card, the adhesive material may also serve as a tamper-resistant mechanism to provide a high risk of destroying either the label or the communication card if an attempt is made to remove the label from the communication card after it has been attached to the communication card. For example, after the cryptographic label has been applied to the surface of the communication card, if an attempt is made to remove the label from the card by peeling off the cryptographic label, the adhesive portion on the bottom side of the skirt may rip apart portions of the communication card to render it unusable.

The invention therefore provides a cryptographic label that may alleviate at least some of the drawbacks associated with known cryptographic expansion devices, particularly those in the form of labels.

Firstly, a skirt which is attached to a flexible printed circuit to form a cryptographic label may allow for the use of a flexible printed circuit of a significantly smaller planar form factor than that of the communication card it is to be attached to. Expenses may be avoided by using the skirt and the adhesive portion thereon, which may be manufactured from a less expensive material or materials than the flexible printed circuit, to affix the cryptographic label to the body of an underlying communication card. This may aid in reducing manufacturing costs and ultimate retail prices of a cryptographic expansion device.

Furthermore, the use of a skirt may make branding easier. Cryptographic devices known in the prior art which can be linked to a communication component of a communication device to enable the communication device to perform cryptographic operations on communications sent to and from the device, are generally manufactured as a circuit structure having an adhesive portion disposed thereon. It may be undesirable to provide circuit structures with indicia, for example, due their composition and/or color. Whereas the color of the cheapest, most easily accessible flexible printed circuits is generally black, the skirt may be of a light color, for example, white.

Importantly, the skirt is not manufactured as a circuit structure and is thus capable of being relatively easily provided with indicia such as printed branding. The skirt may, for example, be manufactured from a plastics material. This may enable conventional printing of branding on the surface of the skirt, and serves to make branding more visible, for example, for the purpose of marketing. This may have the added advantage that the manufacture of the flexible printed circuit may be performed “brand-independently” to possibly further reduce the cost thereof.

Only the skirt itself may then be branded, and the flexible printed circuit can be attached to the skirt during packaging or further manufacturing or assembling steps to form the complete cryptographic label. The skirt may, for example, be provided with indicia associated with a financial service provider such as an issuing bank, the financial service provider being the issuer of the cryptographic label to a consumer in some embodiments. The skirt may also be provided with indicia associated with a payment processing network facilitating use of the cryptographic label, for example, by facilitating end-to-end secure transactions to be routed between various parties to a transaction in a payment network.

The above features may be employed without adverse effects on the cryptographic label and its functionality. The cryptographic label can be attached to the communication component of the communication device to enable the communication device to perform cryptographic operations on communications sent to and from the communication device, for example, to provide it with the capability to send and receive end-to-end encrypted data.

The invention extends to a method of assembling a cryptographic label for enabling a mobile communications device to perform secure communications substantially as described with reference to the figures.

The method of assembling a cryptographic label includes providing a flexible printed circuit substantially as described with reference to any of the above embodiments, the flexible printed circuit having a first set of electrical contacts disposed on a top side of the circuit for interfacing to the mobile communications device, a second set of electrical contacts disposed on a bottom side of the circuit for interfacing to a communication card, and a hardware security module (HSM) disposed in the circuit and coupled to the first and second sets of electrical contacts.

The assembling method further includes providing a skirt substantially as described with reference to any of the above embodiments, the skirt having an adhesive portion on at least a bottom side thereof and capable of having printed indicia such as logos or branding provided on a top side thereof. The cryptographic label and skirt may be separately manufactured.

The method of assembling further includes attaching the skirt to the flexible printed circuit to form the cryptographic label, such that, in use, the adhesive portion on the bottom side of the skirt bonds to a communication card substantially as described in any of the above embodiments so as to attach the cryptographic label to the communication card.

Attachment of the skirt to the flexible printed circuit may include attaching the flexible printed circuit to the adhesive portion on the bottom side of the skirt, or, alternatively, attaching the flexible printed circuit to an adhesive portion on the top side of the skirt. The skirt and flexible printed circuit may be attached at any suitable stage or by any suitable entity, for example, by a manufacturer, during packaging of the cryptographic label, by a merchant providing the cryptographic label, or by an end-consumer.

It is envisaged that the cryptographic label may be attached to a communication card by a manufacturer, issuer or retailer and sold in such a form.

The skirt may be formed from a material already having an adhesive portion or portions. Alternatively, one or more adhesive portions may be added to the skirt after it is formed to desired dimensions.

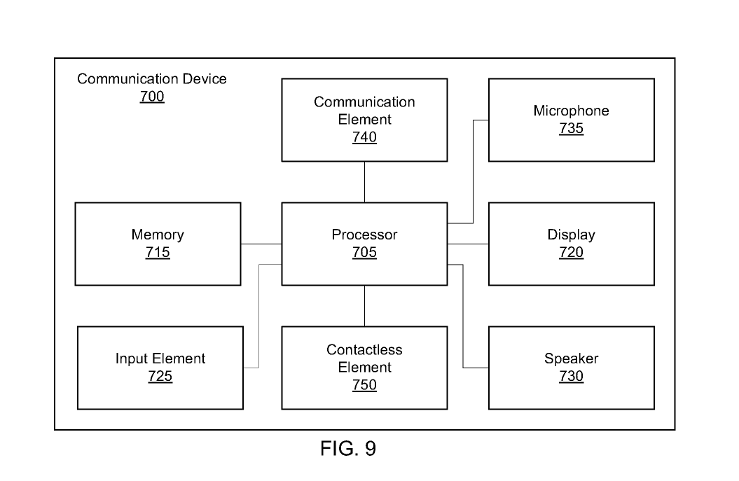

FIG. 9 shows a block diagram of a communication device (700) that may be used in embodiments of the disclosure. The communication device (700) may be a cell phone, a feature phone, a smart phone, a satellite phone, or a computing device having a phone capability.

The communication device (700) may include a processor (705) (e.g., a microprocessor) for processing the functions of the communication device (700) and a display (720) to allow a user to see the phone numbers and other information and messages. The communication device (700) may further include an input element (725) to allow a user to input information into the device (e.g., input buttons, touch screen, etc.), a speaker (730) to allow the user to hear voice communication, music, etc., and a microphone (735) to allow the user to transmit his or her voice through the communication device (700).

The processor (710) of the communication device (700) may connect to a memory (715). The memory (715) may be in the form of a computer-readable medium that stores data and, optionally, computer-executable instructions.

The communication device (700) may also include a communication element (740) for connection to communication channels (e.g., a cellular telephone network, data transmission network, Wi-Fi network, satellite-phone network, Internet network, Satellite Internet Network, etc.). The communication element (740) may include an associated wireless transfer element, such as an antenna.

The communication element (740) may include a communication card such as a SIM card in the form of an integrated circuit that stores an international mobile subscriber identity and the related key used to identify and authenticate a subscriber using the communication device (700). One or more SIM cards may be removable from the communication device (700) or embedded in the communication device (700). The cryptographic label according to embodiments of the invention may be configured to be attached to such a communication element (740).

The communication device (700) may further include a contactless element (750), which is typically implemented in the form of a semiconductor chip (or other data storage element) with an associated wireless transfer element, such as an antenna. The contactless element (750) may be associated with (e.g., embedded within) the communication device (700) and data or control instructions transmitted via a cellular network may be applied to the contactless element (750) by means of a contactless element interface (not shown). The contactless element interface may function to permit the exchange of data and/or control instructions between mobile device circuitry (and hence the cellular network) and the contactless element (750).

The contactless element (750) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device (700) and an interrogation device. Thus, the communication device (700) may be capable of communicating and transferring data and/or control instructions via both a cellular network and near field communications capability.

The data stored in the memory (715) may include: operation data relating to the operation of the communication device (700), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the communication device (700) to selected receivers.

The communication device (700) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A cryptographic label for enabling a mobile communications device to perform secure communications, the label comprising a flexible printed circuit having a first set of electrical contacts disposed on a top side of the circuit for interfacing to the mobile communications device, a second set of electrical contacts disposed on a bottom side of the circuit for interfacing to a communication card, and a hardware security module (HSM) disposed in the circuit and coupled to the first and second sets of electrical contacts, wherein the cryptographic label further comprises a skirt that is attached to the flexible printed circuit, the skirt having an adhesive portion on at least a bottom side thereof and capable of having printed indicia provided on a top side thereof, and wherein, in use, the adhesive portion on the bottom side of the skirt bonds to a communication card so as to attach the cryptographic label to the communication card.

2. The cryptographic label as claimed in claim 1, wherein the skirt is a planar extension member generally coplanar to the flexible printed circuit.

3. The cryptographic label as claimed in claim 1, wherein the flexible printed circuit is attached to the adhesive portion on the bottom side of the skirt.

4. The cryptographic label as claimed in claim 1, wherein the skirt partially extends over at least two edges of the flexible printed circuit such that at least two edges of the bottom side of the skirt rests on the top side of the flexible printed circuit.

5. The cryptographic label as claimed in claim 1, wherein the flexible printed circuit is attached to the bottom side of the skirt, and the skirt includes a set of separately insulated pass-through type conductive channels which extend from the top side to the bottom side of the skirt, and wherein the conductive channels serve to electrically couple the first set of electrical contacts of the flexible printed circuit to a mobile communications device interface so as to enable the cryptographic label to interface to the mobile communications device.

6. The cryptographic label as claimed in claim 1, wherein the skirt includes an adhesive portion on a top side thereof, and wherein the bottom side of the flexible printed circuit is attached to the adhesive portion on the top side of the skirt.

7. The cryptographic label as claimed in claim 6, wherein the skirt includes a set of separately insulated pass-through type conductive channels which extend from the top side to the bottom side of the skirt, the conductive channels serving to electrically couple the second set of electrical contacts of the flexible printed circuit to the communication card so as to enable the cryptographic label to interface to the communication card when the flexible printed circuit is attached to the top side of the skirt.

8. The cryptographic label as claimed in claim 6, wherein the skirt is provided with one or more openings therein so as to enable electrical contacts of the flexible printed circuit to interface to the communication card or the mobile communications device through the openings.

9. The cryptographic label as claimed in claim 8, wherein the skirt is provided with a single central opening.

10. The cryptographic label as claimed in claim 1, wherein the skirt is manufactured substantially from non-conductive materials.

11. The cryptographic label as claimed in claim 1, wherein the skirt is manufactured substantially from flexible plastics material.

12. The cryptographic label as claimed in claim 1, wherein the skirt has a length and a width substantially similar to a length and a width of the communication card the cryptographic label is to be attached to.

13. The cryptographic label as claimed in claim 1, wherein the skirt is sufficiently thin to permit the cryptographic label to be operatively inserted into a communication card receiving slot of the mobile communications device when attached to the communication card.

14. The cryptographic label as claimed in claim 1, wherein the flexible printed circuit is provided with at least two edge portions having surfaces substantially devoid of circuitry, the at least two edge portions defining an attachment area for attachment of the skirt to the flexible printed circuit.

15. The cryptographic label as claimed in claim 1, wherein the mobile communications device is a mobile phone.

16. The cryptographic label as claimed in claim 1, wherein the communication card is a Subscriber Identity Module (SIM) card, and wherein the cryptographic label interfaces to the mobile communications device when received in a SIM card receiving slot of the mobile communications device in use.

17. The cryptographic label as claimed in claim 1, wherein the HSM includes a public processing unit and a secure processing unit, the secure processing unit being accessible by the communication card and/or the mobile communications device only through the public processing unit.

18. A method of assembling a cryptographic label for enabling a mobile communications device to perform secure communications, the method comprising:
providing a flexible printed circuit, the flexible printed circuit having a first set of electrical contacts disposed on a top side of the circuit for interfacing to the mobile communications device, a second set of electrical contacts disposed on a bottom side of the circuit for interfacing to a communication card, and a hardware security module (HSM) disposed in the circuit and coupled to the first and second sets of electrical contacts;
providing a skirt, the skirt having an adhesive portion on at least a bottom side thereof and capable of having printed indicia provided on a top side thereof; and
attaching the skirt to the flexible printed circuit to form the cryptographic label, such that, in use, the adhesive portion on the bottom side of the skirt bonds to a communication card so as to attach the cryptographic label to the communication card.

19. The method as claimed in claim 18, wherein the step of attaching the skirt to the flexible printed circuit includes attaching the flexible printed circuit to the adhesive portion on the bottom side of the skirt.

20. The method as claimed in claim 18, wherein the step of attaching the skirt to the flexible printed circuit includes attaching the flexible printed circuit to an adhesive portion on the top side of the skirt.
